(19) United States
(12) Patent Application Publication
(10) Pub. No.: US 2007/0039882 A1
(43) Pub. Date: Feb. 22, 2007

(54) Integrated nanofiltration process to reduce the alcohol content of alcohol beverages

(76) Inventors: Fernando Manuel Da Silva Goncalves, Lisboa (PT); Norberta Neves Correia De Pinnho Maria, Lisboa (PT)

Correspondence Address: PEARL COHEN ZEDEK, LLP;PEARL COHEN ZEDEK LATZER, LLP, 1500 BROADWAY 12TH FLOOR, NEW YORK, NY, 10036, US

(21) Appl. No.: 10/561,540

(22) PCT Filed: Jun. 18, 2004
(86) PCT No.: PCT/PT04/00014

§ 371 Date: Aug. 28, 2006

(30) Foreign Application Priority Data
Jun. 20, 2003 (PT) 102976

(51) Int. Cl. B01D 65/02

(52) U.S. Cl. 210/636; 210/651; 203/39; 426/592

(57) ABSTRACT

The invention relates to a process for the reduction of the alcohol content of alcoholic beverages, namely wine, preserving the organoleptic characteristics of the original beverage. The process consists of the total or partial removal of the ethanol using nanofiltration membranes (6), which allow the passage of a mixture of water, ethanol and some salts, while retaining the aromatic compounds in the original beverage. The permeate (8), the mixture of water and ethanol that passes through the membrane, is distilled to remove the ethanol. Following the removal of the ethanol (13), this stream (11) is recirculated to the beverage to be treated, allowing the production of a beverage with lower alcohol content that retains the organoleptic properties of the original beverage.

### FIELD OF THE INVENTION

The present invention relates to a process allowing the reduction of the alcohol content of alcoholic beverages while retaining the organoleptic characteristics of the original beverage.

### BACKGROUND OF THE INVENTION

Several approaches have been proposed and tried industrially aiming at the reduction of the ethanol content of alcoholic beverages. Most of these approaches are based on evaporation of the ethanol through techniques such as distillation, evaporation under reduced pressure, evaporation by contact with a counter-flow gaseous current, etc. However, these techniques remove volatile aromatic compounds together with the ethanol, leading to a product with poor aromatic intensity of little interest. A solution for this problem consists of a second distillation operation, to separate the aromatic compounds from the ethanol, which are then returned to the beverage. Although this solution reduces the aroma loss, this manipulation of the aromatic substances has a negative effect on the aromatic profile of the original beverage.

Supercritical extraction has also been used to remove alcohol. This technology also removes volatile aromatic compounds together with the ethanol, requiring a second operation to recover the aromas and to return them to the beverage to be treated, with the consequent disadvantages from the organoleptic point of view.

Another approach consists of the use of reverse osmosis membranes. These membranes allow the permeation of water and ethanol by means of high pressures. Two currents are obtained from the original beverage: one of permeate containing water and ethanol, and one of retentate with the remaining compounds, macromolecules, salts, etc. For example in patent FR 2620129, Dikansky et al., and U.S. Pat. No. 5,324,435, Girard et al., report the use of the reverse osmosis to remove alcohol from wine, with the decrease of the volume of beverage caused by permeation compensated by the addition of water to the retentate. In patent U.S. Pat. No. 4,999,209, Gnekow reports the use of a second unit of reverse osmosis to produce purified water that is added to the retentate. Due to the low ethanol concentration in the permeate the amount of water removed can be large, leading to the addition of a great amount of water to the retentate. One way of solving this problem consists of using the water present in the permeate after distillation as described in patent U.S. Pat. No. 4,812,232, by Weiss, and in patent WO 93 23151 by Smith. The reverse osmosis membranes require the use of very high pressures, usually higher than 40 bar, which, in addition to considerable energy consumption, brings about possible changes of the organoleptic properties of the wine.

### BRIEF DESCRIPTION OF THE DRAWING

FIG. 1 represents the process of reduction of beverage alcohol content.

### SUMMARY OF THE INVENTION

The process of the invention consists of the removal of a mixture of water and ethanol from the beverage, through the use of nanofiltration membranes. This mixture of water and ethanol is distilled, and the base product of distillation, mainly water, is recombined with the beverage. This process can be applied in alcoholic beverages such as wine, beer or cider.

### DETAILED DESCRIPTION OF THE INVENTION

The present invention relates to a process of ethanol removal based on the use of nanofiltration membranes and recombination of the dealcoholized permeate with the beverage. The nanofiltration membranes allow higher permeation flows than reverse osmosis membranes and higher permeation of solutes such as ethanol and salts. The use of nanofiltration membranes to remove ethanol would appear to be more advantageous than reverse osmosis since they allow a higher ethanol permeation flow and consequently a lower permeation volume is necessary. Another advantage of the use of this type of membranes is that the permeate is richer in ethanol than that obtained using reverse osmosis membranes, resulting in a lower difference of osmotic pressures between the retentate and permeate, and so lower working pressures are necessary. These membranes, contrary to reverse osmosis, allow permeation of some salts. Permeation of some ions can be an advantage, as in the case of the acetate ion, as it can be eliminated from the beverage. The ions that cross the membrane to the permeate side are mainly salts or non-volatile acids that are returned to the beverage together with the dealcoholized permeate as explained hereunder. The macromolecules and the aromatic compounds of the original beverage are retained in the retentate, so the body, flavour, aromatic intensity and aromatic profile of the original beverage are unaffected.

The permeate stream obtained by nanofiltration undergoes an operation of ethanol removal, after which it is recombined with the original beverage. The removal of ethanol is carried out by distillation or evaporation, under atmospheric or reduced pressure. The top product of distillation is mainly ethanol and the base product consists of water, salts and a small amount of ethanol. Through the recombination of this distillation base product with the retentate, a beverage whose alcoholic content has been decreased is obtained. The decrease of volume of the beverage, corresponding to the volume of the stream of top of the distillation, can be compensated by the addition of purified water to the beverage.

Thus, a first object of the invention is a process for the reduction of alcohol content of beverages which is performed in a circuit with the following stages:
a. circulation of the beverage from a feed tank, pressurized at maximum 40 bar, tangentially to a NF membrane to obtain two streams:
   i. one of retentate that does not cross the membrane,
   ii. one of permeate that crosses the membrane and is composed of water, ethanol and some salts;
b. recombination of the retentate in the feed tank with the beverage to be processed;
c. distillation of the retentate, at atmospheric or reduced pressure, leading to a top stream rich in ethanol and a bottom stream of dealcoholized permeate;
d. recombination of the dealcoholized permeate in the feed tank with the retentate/beverage;
e. total or partial compensation of the volume loss due to the removal of ethanol by the addition of purified water.

The membranes are adjusted to allow selective permeation of ionic species according to their charge.

The ionic species can be total or partial removed from the dealcoholized permeate (1.c).

In a first embodiment of the process of the invention the membranes are regenerated, with 90% minimum flux recovery, by tangential circulation of water at room temperature.

In a second embodiment of the process of the invention the membranes are regenerated, with 90% minimum flux recovery, by tangential circulation of water at a temperature of 50-60° C.

In a third embodiment of the process of the invention the membranes are regenerated, with 90% minimum flux recovery, by tangential circulation aqueous solutions of weak bases, with controlled pH between 8 and 11, depending on cleaning time. Preferably, the pH is between 8 and 9 for long cleaning.

The process of the invention is carried out in continuous or batch mode.

The final product is obtained by the mixture of the original beverage with beverage treated by this process and presents the same organoleptic characteristics as the original beverage, namely body, flavour, aromatic intensity and aromatic profile.

A second object of the invention is the use of the above process for the reduction or removal of ethanol from beverages such as wine, beer, cider, mead and sake.

Experimental Part

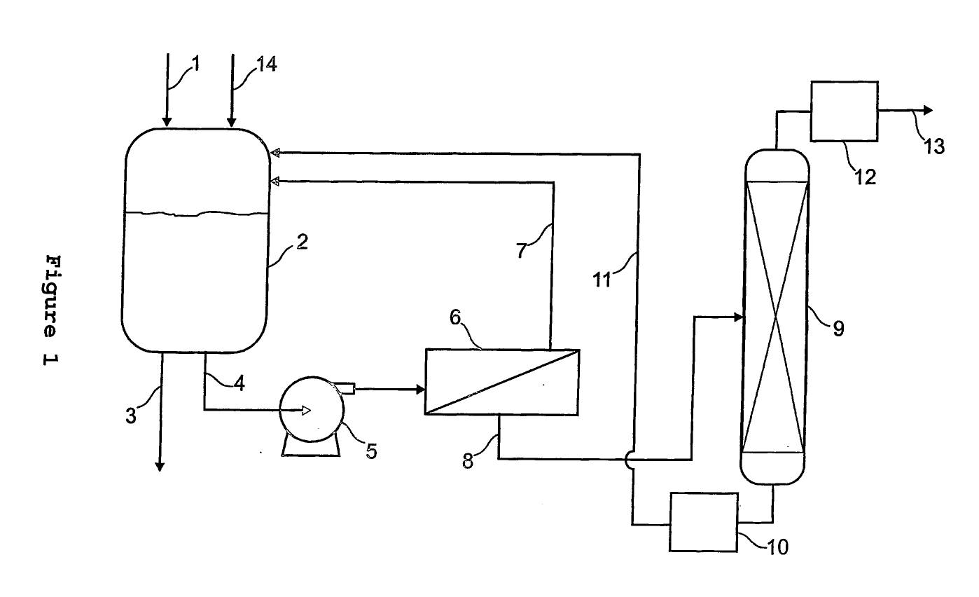

In accordance with FIG. 1 the beverage is fed via inlet 1 to the tank 2 where it will be kept during the process. The liquid leaves the tank to the treatment circuit by outlet 4 while outlet 3 is used to collect the treated beverage. Pump 5 pumps the liquid to be processed, as well as to be pressurised prior to entering the nanofiltration membrane module, 6. After passing through the membrane module the retentate stream 7 is recirculated back to tank 2 and permeate stream 8 passes into a distillation or evaporation unit to undergo ethanol removal. The bottom product of the distillation 10 constitutes the dealcoholized permeate and it is driven to tank 2 through inlet 11. The top product of distillation 12, mainly ethanol, is collected via outlet 13. The dealcoholization of the permeate can be carried out in continuous or batch mode. The decrease of volume of the beverage, corresponding to the volume of distillate, can be compensated by the addition of purified water to the tank 2 via inlet 14.

This process can be operated in continuous mode, the beverage entering via inlet 1 and the treated beverage leaving via exit 3, or in batch mode through filling tank 2 and recirculation of the liquid until the desired alcoholic degree is obtained.

### EXAMPLE 1

A volume of 3 litres of rosé wine with 10.7% alcohol v/v, was treated using a nanofiltration membrane HC50 (DDS, Denmark) with 0.108 m² total surface area. The wine was pressurized at 15 bar and circulated tangentially to the membrane, at 25° C., for 3 h and 1.05 L of permeate was collected. The permeate was evaporated under vacuum at 40° C. A product with high concentration of ethanol, 80% v/v, and a dealcoholized product containing 0.5% v/v of ethanol were obtained. This dealcoholized product was recombined with 1.9 L of retentate, resulting in a wine whose alcoholic content was reduced to 7.3% v/v. A panel of 4 tasters compared the original wine and the wine with low alcoholic content obtained. It was found that the wine with reduced alcohol content had the flavour and aromatic profile of the original wine.

The membranes were regenerated by means of tangential circulation of water at room temperature for 30 minutes. This procedure allowed the recovery of 98% of the membrane's original flow, allowing reuse of the membrane while retaining its original characteristics.

### EXAMPLE 2

A volume of 2.25 litres of red wine with 11.1% alcohol v/v, was treated using a nanofiltration membrane HC50 (DDS, Denmark) with 0.108 m² total surface area. The wine was pressurized at 15 bar and circulated tangentially to the membrane for 1 h 40 m, at 25° C., and 0.84 L of permeate was collected. The permeate was evaporated under vacuum at 40° C. A product with high concentration of ethanol, 80% v/v, and a dealcoholized product containing 0.5% v/v of ethanol were obtained. This dealcoholized product was recombined with 1.4 L of retentate, resulting in a wine whose alcoholic content was reduced to 8% v/v. A panel of 4 tasters compared the original wine and the wine with low alcoholic content obtained. It was found that the wine with reduced alcohol content had the flavour and aromatic profile of the original wine.

The membranes were regenerated by means of tangential circulation of water at 50-60° C. for 30 minutes, followed by an Na₂CO₃ solution at 0.1%, pH 9, at 50-60° C. for 45 minutes. This procedure allowed the recovery of 99% of the membrane's original flow, allowing reuse of the membrane while retaining its original characteristics.

1. A process for the reduction of alcohol content of beverages comprising the steps of:
a. circulating the beverage from a feed tank, pressurized at maximum 40 bar, tangentially to a NF membrane to obtain two streams:
i. one of retentate that does not cross the NF membrane,
ii. one of permeate that crosses the NF membrane and is composed of water, ethanol and salts;
b. recombining the retentate in the feed tank with the beverage to be processed;
c. distilling the retentate, at atmospheric or reduced pressure, leading to a top stream rich in ethanol and a bottom stream of dealcoholized permeate;
d. recombining of the dealcoholized permeate in the feed tank with the retentate/beverage;
e. totally, or partially compensating for volume loss due to the removal of ethanol by the addition of purified water.

2. Process in accordance with claim 1 wherein the membrane is adjusted to allow selective permeation of ionic species according to their charge.

3. Process in accordance with claim 1, wherein the ionic species can be total or partial removed from the bottom stream of dealcoholized permeate.

4. Process in accordance with claim 1, wherein the membrane is regenerated, with 90% minimum flux recovery, by tangential circulation of water at room temperature.

5. Process in accordance with claim 1, wherein the membrane is regenerated, with 90% minimum flux recovery, by tangential circulation of water at a temperature of 50-60° C.

6. Process in accordance with claim 1, wherein the membranes are regenerated, with 90% minimum flux recovery, by tangential circulation aqueous solutions of weak bases, with controlled pH between 8 and 11, as a function of cleaning time.

7. Process in accordance with claim 6 wherein a pH between 8 and 9 is used for a long cleaning time.

8. Process in accordance with claim 1, carried out in a continuous or a batch mode.

9. Process in accordance with claim 1, wherein the final product is obtained by the mixture of the original beverage with beverage treated by this process.

10. Process in accordance with claim 1, the final product presents the same organoleptic characteristic of the original beverage.

11. (canceled)

12. The process of claim 1, wherein said beverage is wine, beer, cider, mead or sake.

13. The process of claim 10, wherein the organoleptic characteristic is body, flavour, aromatic intensity or aromatic profile.
